(19) United States
(12) Patent Application Publication
(10) Pub. No.: US 2008/0062694 A1
(43) Pub. Date: Mar. 13, 2008

(54) HEAT DISSIPATION DEVICE FOR LIGHT EMITTING DIODE MODULE

(75) Inventors: Cheng-Tien Lai, Tu-Cheng (TW); Zhi-Yong Zhou, Shenzhen (CN); Qiao-Li Ding, Shenzhen (CN)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Tu-Cheng (TW)

(21) Appl. No.: 11/309,661

(22) Filed: Sep. 7, 2006

(51) Int. Cl. F21V 29/00

(52) U.S. Cl. 362/294

(57) ABSTRACT

A heat dissipation device for a light emitting diode (LED) module includes a liquid cooling system. The liquid cooling system includes a heat-absorbing member, which includes an inlet, an outlet and at least one pipe extending between the inlet and the outlet. The inlet and the outlet are provided for permitting liquid to flow through the at least one pipe, which is in thermal contact with at least one LED of the LED module.

### FIELD OF THE INVENTION

The present invention relates to a heat dissipation device, more particularly to a heat dissipation device for a light emitting device module.

### DESCRIPTION OF RELATED ART

A light emitting diode (LED) is a device for transferring electricity to light by using a theory that, if a current is made to flow in a forward direction in a junction comprising two different semiconductors, electrons and holes are coupled at a junction region to generate a light beam. The LED has an advantage in that it is resistant to shock, and has an almost eternal lifetime under a specific condition, so more and more LED modules with different capabilities are being developed.

LED modules for use in a display or an illumination device require many LEDs, and most of the LEDs are driven at the same time, which results in a quick rise in temperature of the LED module. Since generally the LED modules do not have heat dissipation devices with good heat dissipating efficiencies, operation of the general LED modules has a problem of instability because of the rapid build up of heat. Consequently, the light from the LED module often flickers, which degrades the quality of the display or illumination.

What is needed, therefore, is a heat dissipation device for an LED module, which can overcome the above-described disadvantages.

### SUMMARY OF THE INVENTION

A heat dissipation device for a light emitting diode (LED) module is disclosed. The heat dissipation device comprises a liquid cooling system. The liquid cooling system comprises a heat-absorbing member, which comprises an inlet, an outlet and at least one pipe extending between the inlet and the outlet. The inlet and the outlet are provided for permitting liquid to flow through the at least one pipe, which is in thermal contact with at least one LED of the LED module.

Other advantages and novel features will become more apparent from the following detailed description of preferred embodiments when taken in conjunction with the accompanying drawings, in which:

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an isometric view of a heat dissipation device in accordance with a first preferred embodiment, together with an LED module, wherein one of printed circuit boards of the LED module is removed away to clearly show relationship between the heat dissipation device and LEDs of the LED module;

FIG. 2 is similar to FIG. 1, but viewed from another aspect;

FIG. 3 is an isometric view of a heat-absorbing member of a heat dissipation device in accordance with another preferred embodiment, together with an LED module;

FIG. 4 is similar to FIG. 3, but viewed from another aspect;

FIG. 5 is an exploded view of the heat-absorbing member in FIG. 3; and

FIG. 6 is an isometric view of a heat-absorbing member of a heat dissipation device in accordance with another preferred embodiment.

### DETAILED DESCRIPTION OF THE INVENTION

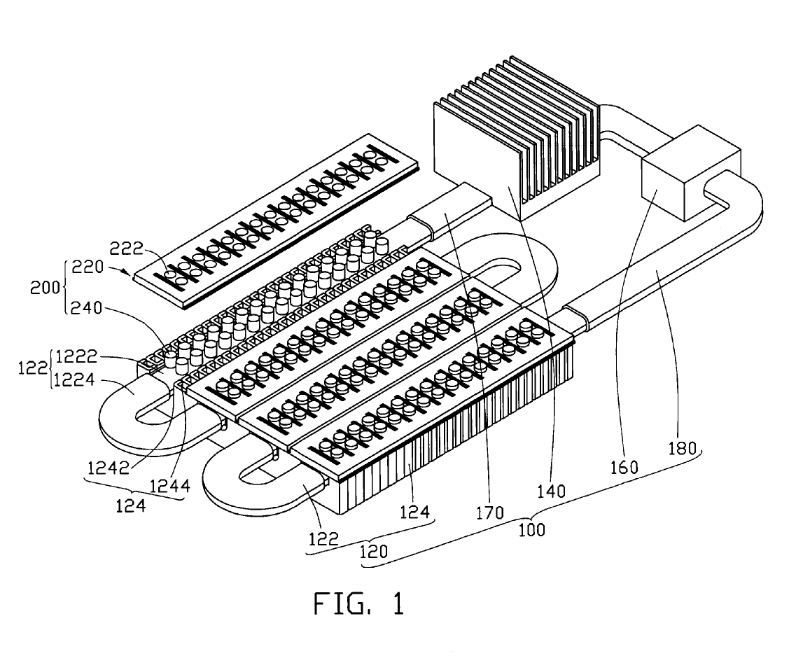

Referring to FIG. 1, a heat dissipation device 100 in accordance with a first preferred embodiment is illustrated. The heat dissipation device 100 is used to cool down an LED module 200 to keep the LED module 200 working within an acceptable temperature range.

In this embodiment, the LED module 200 comprises several juxtaposed printed circuit boards 220 and a plurality of LEDs 240 electrically bonded to the printed circuit boards 220. Each printed circuit board 220 has a plurality of through holes 222 defined therein. The through holes 222 are arrayed in rows and lines for the LEDs 240 extending therethrough. Alternatively, these printed circuit boards 220 can be replaced by a larger single printed circuit board, which has a matrix of through holes defined therein. The LEDs 240 are installed into the corresponding through holes 222 of the printed circuit boards 220, and electrically connected to circuits (not shown) provide on the printed circuit boards 220. Therefore, the LED module 200 is formed. For facilitating heat dissipation of the LEDs 240, bottom surfaces of the LEDs 240 commonly define a surface coplanar with a bottom surface commonly defined by the printed circuit boards 220, or located in a level below the bottom surface of the printed circuit boards 220.

Before the LED module 200 is driven to generate light, the heat dissipation device 100 is mounted on the bottom surface of the printed circuit boards 220.

The heat dissipation device 100 is a liquid cooling system, and comprises a heat-absorbing member 120, a heat-dissipating member 140, a pump 160, a supply pipe 170 and a delivery pipe 180. The hear-absorbing member 120, the heat-dissipating member 140, the pump 160, the supply pipe 170 and the delivery pipe 180 together form a loop for circulation of liquid. The pump 160 draws the liquid from the heat-absorbing member 120 via the delivery pipe 180, and supplies the liquid back to the heat-absorbing member 120 via the supply pipe 170. The heat-dissipating member 140 is mounted on the supply pipe 170 such that the liquid is sufficiently cooled while passing the supply pipe 170.

The heat-absorbing member 120 is tightly attached to the bottom surface of the printed circuit boards 220 so as to absorb heat originated from the LEDs 240. In this embodiment, the heat-absorbing member 120 comprises a serpentine flattened pipe 122. The serpentine flattened pipe 122 comprises four juxtaposed straight pipes 1222 and three elbows 1224. The straight pipes 1222 are parallel to each other and separated from each other by a certain distance determined by the arrangement of the LEDs 240 on the printed circuit boards 220. The rightmost straight pipe 1222 has an end connected to the delivery pipe 180, thereby serving as an outlet (not labeled) for the flatten pipe 122; the leftmost straight pipe 1222 has an end connected to the supply pipe 170, thereby serving as an inlet (not labeled) for the flatten pipe 122. The elbows 1224 hermetically interconnect the remaining ends of the neighboring straight pipes 1222 to form a serial and serpentine channel extending between the inlet and the outlet.

Additionally, the number of the straight pipes 1222 may be increased or decreased via increasing or decreasing the number of the elbows 1224, according to the requirement of heat dissipating. Therefore, the heat-absorbing member 120 has a high versatility of use.

When the LEDs 240 are driven to luminance, the liquid is driven to flow along the serpentine channel of the heat-absorbing member 120 by the pump 160, and heated up by the heat produced by the LEDs 240 which are directly contact with the straight pipes 1222. The heated liquid is then forced to flow across the heat-dissipating member 140 to dissipate the heat to ambient air, whereby the heated liquid is cooled before it returns back to the heat-absorbing member 120 for another circulation. Therefore, the heat of the LEDs 240 is removed away, and the LEDs 240 can work within an acceptable temperature range.

As described above, the straight pipes 1222 of the heat-absorbing member 120 are directly contacted with the LEDs 240, wherein the LEDs 240 in contact with one of the straight pipes 1222 are arranged in two parallel lines. The straight pipes 1222 transfer the heat from the LEDs 240 to the liquid flowing past the heat-absorbing member 120.

For further improving the heat dissipating efficiency, the heat-absorbing member 120 further comprises a plurality of fins 124 tightly attached to the bottom surface of the printed circuit boards 220, and transverse to the straight pipes 1222. Each fin 124 has four cutouts 1242 defined in a top portion thereof. When the fins 124 are combined together, the cutouts 1242 cooperatively define four straight grooves lengthwise extending in a top portion of the fins 124, for accommodating the straight pipes 1222 therein. Each fin 124 has flanges 1244 each perpendicularly extending from the fin at a periphery of the corresponding cutout 1242, to increase the contacting area between the fins 124 and the straight pipes 1222. Therefore, part of the heat carried by the liquid is first transferred to the fins 124 via the flanges 1244 to be dissipated, prior to the liquid flowing into the heat-dissipating member 140 to be cooled.

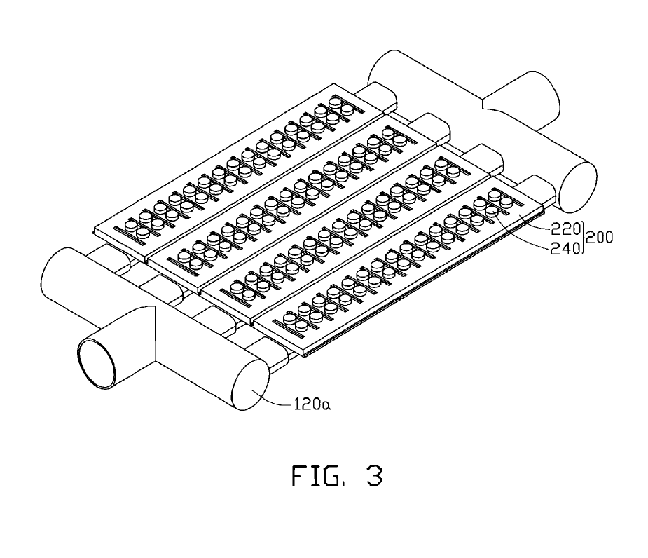

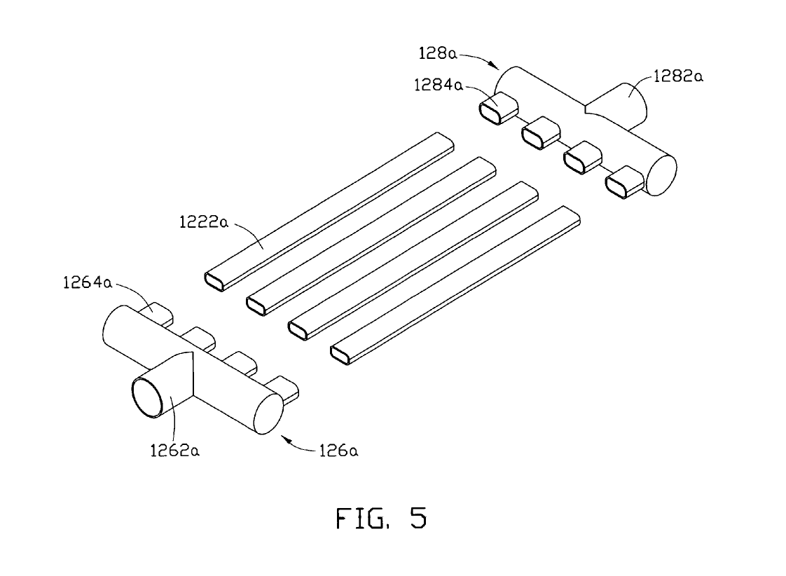

FIGS. 3-5 show another heat-absorbing member 120a. The heat absorbing-member 120a comprises a diverging member 126a, a converging member 128a and four straight pipes 1222a. The diverging member 126a comprises an inlet 1262a for being coupled to a supply pipe (not shown), and four outlets 1264a branching from the diverging member 126a. The converging member 128a comprises an outlet 1282a for being coupled to a delivery pipe, and four inlets 1284a converged at the converging member 128a to the outlet 1282a. Opposite ends of each straight pipe 1222a are respectively coupled to a corresponding inlet 1284a of the converging member 128a and a corresponding outlet 1264a of the diverging member 126a. In other words, each straight pipe 1222a interconnects one outlet 1264a of the diverging member 126a and a corresponding inlet 1284a of the converging member 128a, whereby the straight pipes 1222a are positioned between the diverging member 126a and converging member 128a in parallel.

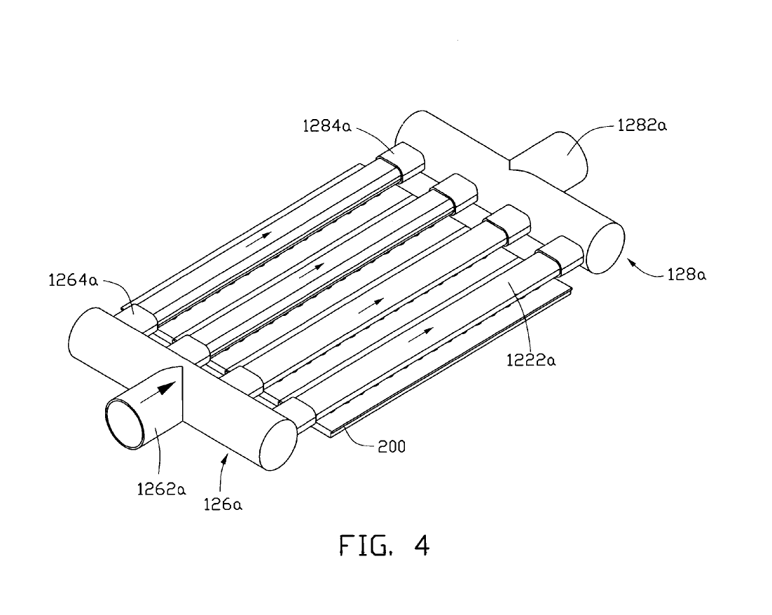

Liquid flowing into the inlet 1262a of the diverging member 126a will be divided into four branches at the outlets 1264a. Then the four branches of the liquid simultaneously flow towards the inlets 1284a of the converging member 128a along the straight pipes 1222a as shown by arrows of FIG. 4. Finally, the four branches of the liquid converge at the converging member 128a before the liquid flows into the delivery pipe from the outlet 1282a of the converging member 128a. When the liquid flows past the straight pipes 1222a of the heat-absorbing member 120a, the heat produced by the LEDs 240 is conducted to the liquid, and then conveyed to the heat-dissipating member remote from the heat-absorbing member 120a to be dissipated into the ambient air.

In this embodiment, the liquid flowing in each straight pipe 1222a is diverged in parallel from the diverging member 126a and then respectively flows in different straight pipes 1222a. The liquid in one straight pipe 1222a can not enter another straight pipe 1222a so that the liquid in different straight pipes 1222a does not interact with each other. Therefore, heat in liquid flowing in one straight pipe 1222a can not transferred to the liquid flowing in a different straight pipe 1222a, whereby even if the liquid in one straight pipe 1222a is overheated, the overheated liquid will not increase the temperature of the liquid in a different straight pipe 1222a.

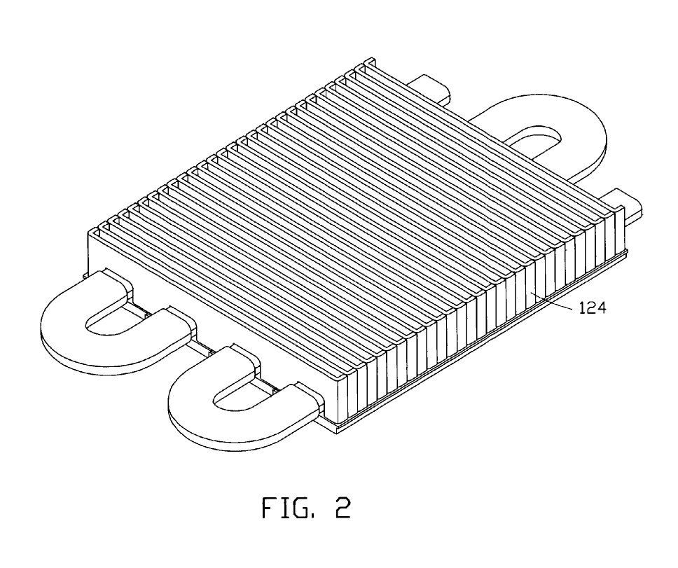

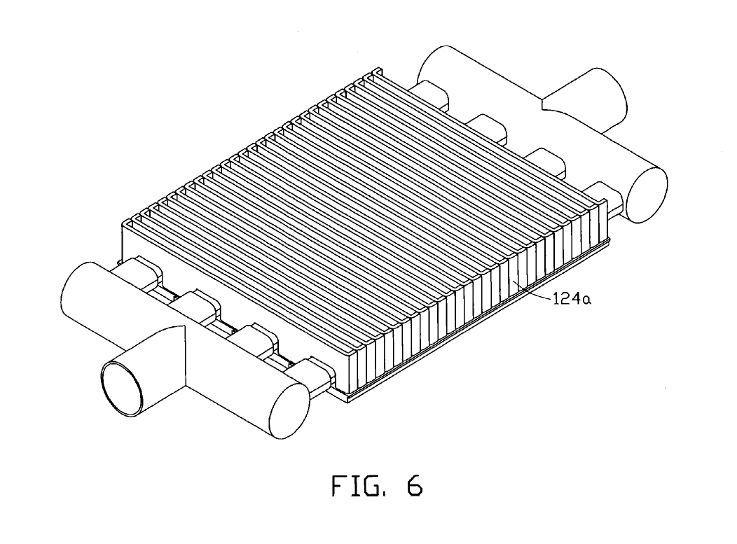

Referring to FIG. 6, for further improving the heat dissipating efficiency, a plurality of fins 124a are attached to the bottom surface of the printed circuit boards 220a and transverse to the straight pipes 1222a in a similar manner as shown in FIG. 2. A part of heat received by the straight pipes 1222a is dissipated to the ambient air by the fins 124a.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

1. A heat dissipation device for a light emitting diode (LED) module, the heat dissipation device comprising:
a liquid cooling system comprising a heat-absorbing member, the heat-absorbing member comprising an inlet, an outlet and at least one pipe extending between the inlet and the outlet, wherein the inlet and the outlet are provided for permitting liquid to flow through the at least one pipe which is in thermal contact wit at least one LED of the LED module;
wherein the heat-absorbing member further comprises a plurality of fins. and the at least one pipe is inserted in the fins.

2. The heat dissipation device as claimed in claim 1, wherein the heat-absorbing member comprises a plurality of straight pipes each in thermal contact with at least one LED of the LED module, and a plurality of elbows serially interconnecting the straight pipes, wherein the straight pipes and the elbows corporately form a serpentine channel extending between the inlet and the outlet.

3. (canceled)

4. The heat dissipation device as claimed in claim 1, wherein each fin has at least one cutout, and the at least one cutout of the each fm aligns with each other to form a groove for accommodating the at least one pipe therein.

5. The heat dissipation device as claimed in claim 4, wherein the each fin comprises flanges beside the at least one cutout

6. The heat dissipation device as claimed in claim 4, wherein the fins are oriented to be transverse to the at least one pipe.

7. The heat dissipation device as claimed in claim 1, wherein the heat absorbing-member comprises a diverging member, a converging member and a plurality of parallel, straight pipes interconnecting the diverging member and the converging member.

8. The heat dissipation device as claimed in claim 7, wherein the inlet is formed at the diverging member, and the diverging member comprises a plurality of outlets branching from the diverging member and hermetically coupled to first ends of the straight pipes.

9. The heat dissipation device as claimed in claim 8, wherein the outlet is formed at the converging member, and the converging member comprises a plurality of inlets converged at the converging member and hermetically coupled to second ends of the straight pipes.

10. An LED package, comprising;
a printed circuit board having a plurality of LEDs arrayed thereon; and
a liquid cooling system, the liquid cooling system comprising: a heat-absorbing member comprising a plurality of pipes attached to a bottom surface of the printed circuit board for in thermal contact with the LEDs; and a pump for driving liquid flowing through the pipes of the heat-absorbing member;
wherein the heat-absorbing member further comprises plurality of fins mounted on the bottom surface of the printed circuit board, and the pipes are sandwiched between the fins and the printed circuit board.

11. The LED package as claimed in claim 10, wherein the liquid cooling system further comprises a heat-dissipating member and tubes connecting the pipes with the heat-dissipating member to form a loop for circulation of the liquid.

12. The LED package as claimed in claim 10, wherein the pipes of the heat-absorbing member comprise a plurality of straight pipes and a plurality of bent pipes interconnecting the straight pipes, and wherein the straight pipes and the bent pipes corporately form a serial and serpentine channel for the liquid flowing therein.

13. The LED package as claimed in claim 10, wherein the beat absorbing-member comprises a diverging member and a converging member, and the pipes are parallel to each other and interconnect the diverging member and the converging member.

14. (canceled)

15. The LED package as claimed in claim 10, wherein the printed circuit board defines a plurality of through holes therein for the LEDs extending therethrough and electrically bonded to the printed circuit board.

16. The LED package as claimed in claim 15, wherein bottom surfaces of the LEDs commonly define a surface for directly contacting with the pipes of the heat-absorbing member, and wherein the surface of the LEDs is coplanar with the bottom surface of the printed circuit board.

17. The LED package as claimed in claim 15, wherein bottom surfaces of the LEDs commonly define a surface for directly contacting with the pipes of the heat-absorbing member, and wherein the surface of the LEDs is located at a level below the bottom surface of the printed circuit board.

18. A light-emitting-diode (LED) module comprising:
a plurality of LEDs arranged on a printed circuit;
a plurality of pipes with which bottoms of the plurality of LEDs are thermally connected, wherein fluid flows through the pipes to take heat generated by the LEDs away from the LEDs;
wherein the light-emitting-diode module further comprises a plurality of fins, and adjacent pipes are separated from each other by the fins.

19. The light-emitting-diode module as claimed in claim 18, wherein the pipes are connected together in a serial manner.

20. The light-emitting-diode module as claimed in claim 18, wherein the pipes are arranged in a parallel manner.
